(19) United States
(12) Patent Application Publication
(10) Pub. No.: US 2016/0112219 A1
(43) Pub. Date: Apr. 21, 2016

(54) ANTENNA STRUCTURES AND ELECTRONICS DEVICE HAVING THE SAME

(71) Applicants: Youngki LEE, Incheon (KR); Iljong SONG, Suwon-si (KR); Jaesuk LEE, Suwon-si (KR); Yohan JANG, Seoul (KR); Byeonghoon LEE, Seoul (KR)

(72) Inventors: Youngki LEE, Incheon (KR); Iljong SONG, Suwon-si (KR); Jaesuk LEE, Suwon-si (KR); Yohan JANG, Seoul (KR); Byeonghoon LEE, Seoul (KR)

(21) Appl. No.: 14/842,959

(22) Filed: Sep. 2, 2015

(30) Foreign Application Priority Data
Oct. 20, 2014 (KR) 10-2014-0141923

(51) Int. Cl. H04L 25/02; H04B 5/00; H04W 4/00

(52) U.S. Cl. CPC H04L 25/0278; H04W 4/008; H04B 5/0031

(57) ABSTRACT

A near-field communication (NFC) device may include: an NFC circuitry configured to perform NFC; an antenna structure connected to the NFC circuitry; and/or a matching circuit configured to perform impedance matching between the NFC circuitry and the antenna structure. The antenna structure may include: an antenna segment configured to form a metal frame surrounding a periphery of a body including the NFC circuitry and the matching circuit; and/or a first slit formed between first and second ends of the antenna segment. The antenna segment may include a first feeding terminal and a second feeding terminal respectively formed at the first and second ends of the antenna segment. The first feeding terminal of the antenna segment may be connected to a first end of the matching circuit. The second feeding terminal of the antenna segment may be connected to a second end of the matching circuit.

### CROSS-REFERENCE TO RELATED APPLICATION(S)

This application claims priority from Korean Patent Application No. 10-2014-0141923, filed on Oct. 20, 2014, in the Korean Intellectual Property Office (KIPO), the entire contents of which are incorporated herein by reference.

### BACKGROUND

1. Field

Example embodiments of the inventive concepts may generally relate to antenna structures. Example embodiments of the inventive concepts may generally relate to electronic device having antenna structures. Example embodiments of the inventive concepts may generally relate to near-field communication (NFC) antenna structures, using metal frames, with electronic devices, such as mobile devices.

2. Description of Related Art

As an example of electronic devices, a mobile device, such as a smart phone or a tablet personal computer (PC), may include a chip-type near-field communication (NFC) circuitry to perform NFC with an external device. Also, an additional antenna for NFC may be attached to the inside of the mobile device or one surface of a battery installed in the mobile device.

However, in recent years, as mobile devices become thinner and thinner, a body housing of a mobile device may be covered with a cover formed of metal material to compensate for a reduction in the physical strength of the mobile device. However, when the cover of the mobile device is formed of metal material, an NFC antenna disposed in the mobile device may be shielded by the cover formed of the metal material, which may degrade antenna performance.

In addition, since an NFC antenna may be conventionally disposed in a rear portion of the mobile device, a front portion of the mobile device may have poorer antenna performance than the rear portion of the mobile device.

### SUMMARY

Some example embodiments of the inventive concepts provide antenna structures for improving near-field communication (NFC) of mobile devices.

Some example embodiments of the inventive concepts provide mobile devices having antenna structures for improving NFC antenna performance.

In some example embodiments, a near-field communication (NFC) device may comprise: an NFC circuitry configured to perform NFC; an antenna structure connected to the NFC circuitry; and/or a matching circuit configured to perform impedance matching between the NFC circuitry and the antenna structure. The antenna structure may comprise: an antenna segment configured to form a metal frame surrounding a periphery of a body including the NFC circuitry and the matching circuit; and/or a first slit formed between first and second ends of the antenna segment. The antenna segment may comprise a first feeding terminal and a second feeding terminal respectively formed at the first and second ends of the antenna segment. The first feeding terminal of the antenna segment may be connected to a first end of the matching circuit. The second feeding terminal of the antenna segment may be connected to a second end of the matching circuit.

In some example embodiments, the antenna segment may not be directly grounded.

In some example embodiments, the antenna segment may be connected in parallel to a capacitor included in the matching circuit. The antenna segment may be configured to operate as a resonator having an appropriate resonance frequency for the NFC.

In some example embodiments, the antenna structure may further comprise an NFC antenna including an NFC antenna pattern. The NFC antenna and the antenna segment may be connected in parallel to the matching circuit.

In some example embodiments, the antenna structure may further comprise a cover configured to protect the body and formed of metal. The cover may comprise a second slit formed at one side of the cover and comprises a third feeding terminal and a fourth feeding terminal formed with the second slit interposed therebetween. The third feeding terminal and the first feeding terminal may be connected in parallel to the first end of the matching circuit. The fourth feeding terminal and the second feeding terminal may be connected in parallel to the second end of the matching circuit.

In some example embodiments, the cover may further comprise an opening that extends from a first end of the second slit and has a greater width than the second slit.

In some example embodiments, the first slit and the second slit may be filled with insulating material or dielectric material.

In some example embodiments, a near-field communication (NFC) device may comprise: an NFC circuitry configured to perform NFC; an antenna structure connected to the NFC circuitry; and/or a matching circuit configured to perform impedance matching between the NFC circuitry and the antenna structure. The antenna structure may comprise: a plurality of antenna segments configured to form a metal frame surrounding a periphery of a body including the NFC circuitry and the matching circuit; and/or a plurality of slits formed among the plurality of antenna segments. Each of the plurality of antenna segments may comprise a first feeding terminal and a second feeding terminal respectively formed at first and second ends of the respective antenna segment. The first feeding terminals may be connected in parallel to a first end of the matching circuit. The second feeding terminals may be connected in parallel to a second end of the matching circuit.

In some example embodiments, each of the plurality of antenna segments may not be directly grounded.

In some example embodiments, each of the plurality of antenna segments may be connected in parallel to a capacitor included in the matching circuit. Each of the plurality of antenna segments may be configured to operate as a resonator having an appropriate resonance frequency for the NFC.

In some example embodiments, the NFC device may further comprise: a plurality of switches respectively interposed between the plurality of antenna segments and the matching circuit.

In some example embodiments, a near-field communication (NFC) device may comprise: an NFC circuitry configured to perform NFC; an antenna structure connected to the NFC circuitry; and/or a matching circuit configured to perform impedance matching between the NFC circuitry and the antenna structure. The antenna structure may comprise: a plurality of antenna segments configured to form a metal frame surrounding a periphery of a body including the NFC circuitry and the matching circuit; and/or a plurality of slits formed among the plurality of antenna segments. Each of the plurality of antenna segments may comprise feeding terminals respectively formed at first and second ends of the respective antenna segment. The plurality of antenna segments may be connected in series by electrically connecting adjacent feeding terminals among the feeding terminals formed in adjacent antenna segments. A feeding terminal that is not connected in serial, among feeding terminals of a first antenna segment of the antenna segments connected in series, may be connected to a first end of the matching circuit. A feeding terminal that is not connected in serial, among feeding terminals of a final antenna segment of the antenna segments connected in series, may be connected to a second end of the matching circuit.

In some example embodiments, each of the plurality of antenna segments may not be directly grounded.

In some example embodiments, the plurality of antenna segments connected in series may be connected in parallel to a capacitor included in the matching circuit. The plurality of antenna segments connected in series may be configured to operate as a resonator having an appropriate resonance frequency for the NFC.

In some example embodiments, a near-field communication (NFC) antenna structure may comprise: at least one antenna segment configured to form a metal frame having a height and having a central hollow portion; and/or at least one slit formed among the at least one antenna segment. Each of the at least one antenna segment may comprise a first feeding terminal and a second feeding terminal respectively formed at first and second ends of the respective antenna segment. The first feeding terminal may be connected to a first end of a matching circuit. The second feeding terminal may be connected to a second end of the matching circuit.

In some example embodiments, each of the at least one antenna segment may not be directly grounded.

In some example embodiments, a near-field communication (NFC) antenna structure may comprise: a plurality of antenna segments configured to form a metal frame having a height and a central hollow portion; and/or a plurality of slits formed among the plurality of antenna segments. Each of the plurality of antenna segments may comprise feeding terminals respectively formed at first and second ends of the respective antenna segment. The plurality of antenna segments may be connected in series by electrically connecting adjacent feeding terminals among the feeding terminals formed in adjacent antenna segments. A feeding terminal that is not connected in serial, among feeding terminals of a first antenna segment of the antenna segments connected in series, may be connected to a first end of a matching circuit, and a feeding terminal that is not connected in serial, from among feeding terminals of a final antenna segment of the antenna segments connected in series, may be connected to a second end of the matching circuit.

In some example embodiments, each of the plurality of antenna segments may not be directly grounded.

In some example embodiments, an electronic device may comprise a near-field communication (NFC) device. The NFC device may comprise: an NFC circuitry configured to perform NFC; an antenna structure connected to the NFC circuitry; and/or a matching circuit configured to perform impedance matching between the NFC circuitry and the antenna structure. The antenna structure may comprise: an antenna segment configured to form a metal frame surrounding a periphery of a body including the NFC circuitry and the matching circuit; and/or a first slit formed between first and second ends of the antenna segment. The antenna segment may comprise a first feeding terminal and a second feeding terminal respectively formed at the first and second ends of the antenna segment. The first feeding terminal of the antenna segment may be connected to a first end of the matching circuit, and the second feeding terminal of the antenna segment may be connected to a second end of the matching circuit. The electronic device may be configured to perform NFC with an external device through the NFC device.

In some example embodiments, the electronic device may be a mobile device.

In some example embodiments, the electronic device may be configured to perform NFC with an external device through the NFC device.

In some example embodiments, the electronic device may be a mobile device.

In some example embodiments, wherein the electronic device may be configured to perform NFC with an external device through the NFC device.

In some example embodiments, the electronic device may be a mobile device.

In some example embodiments, the NFC device may further comprise a first switch, interposed between the antenna segment and the matching circuit, and a second switch, interposed between the NFC antenna and the matching circuit.

In some example embodiments, the NFC device may further comprise a first switch, interposed between the antenna segment and the matching circuit, and a second switch, interposed between the cover and the matching circuit.

In some example embodiments, a near-field communication (NFC) device may comprise: NFC circuitry configured to perform NFC; an antenna structure configured to transmit and receive radio frequency communications; a matching circuit configured to perform impedance matching between the NFC circuitry and the antenna structure; and/or a body comprising the NFC circuitry and the matching circuit. The antenna structure may comprise an antenna segment configured to form a metal frame on a periphery of the body. The antenna segment may comprise a first feeding terminal at a first end of the antenna segment. The antenna segment may comprise a second feeding terminal at a second end of the antenna segment. The first and second feeding terminals may be connected to the matching circuit.

In some example embodiments, the antenna segment may not be directly grounded.

In some example embodiments, the antenna segment may be connected in parallel to a capacitor in the matching circuit.

In some example embodiments, the antenna segment may be configured to operate as a resonator having an appropriate resonance frequency for the NFC.

In some example embodiments, the antenna structure may further comprise an NFC antenna including an NFC antenna pattern.

In some example embodiments, the NFC antenna and the antenna segment may be connected in parallel to the matching circuit.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a configuration diagram of a mobile device according to some example embodiments of the inventive concepts;

FIG. 2 is a diagram of a structure of a metal frame of FIG. 1, according to some example embodiments of the inventive concepts;

FIG. 3 is a block diagram of a near-field communication (NFC) device according to some example embodiments of the inventive concepts;

FIG. 4 is a circuit diagram of an NFC device according to some example embodiments of the inventive concepts;

FIG. 5 is a configuration diagram of an NFC device according to some example embodiments of the inventive concepts;

FIG. 6 is an equivalent circuit of a metal frame of FIG. 5, according to some example embodiments of the inventive concepts;

FIG. 7 is a configuration diagram of an NFC device according to some example embodiments of the inventive concepts;

FIG. 8 is an equivalent circuit of a metal frame of FIG. 7, according to some example embodiments of the inventive concepts;

FIG. 9 is a configuration diagram of an NFC device according to some example embodiments of the inventive concepts;

FIG. 10 is an equivalent circuit of a metal frame of FIG. 9, according to some example embodiments of the inventive concepts;

FIG. 11 is a configuration diagram of an NFC device according to some example embodiments of the inventive concepts;

FIG. 12 is a configuration diagram of a mobile device according to some example embodiments of the inventive concepts;

FIG. 13 is an equivalent circuit of an antenna structure of FIG. 12, according to some example embodiments of the inventive concepts;

FIG. 14 is a block diagram of a mobile device according to some example embodiments of the inventive concepts; and

FIG. 15 is an equivalent circuit of FIG. 8, to which switches are added.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

In the drawing figures, the dimensions of layers and regions may be exaggerated for clarity of illustration Like reference numerals refer to like elements throughout. The same reference numbers indicate the same components throughout the specification.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made to example embodiments, which are illustrated in the accompanying drawings, wherein like reference numerals may refer to like components throughout.

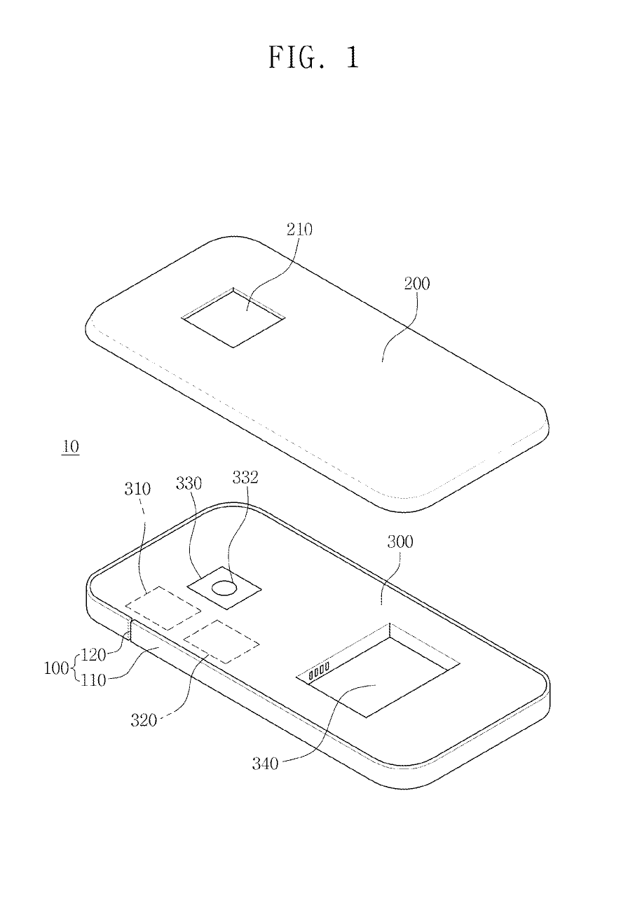

FIG. 1 is a configuration diagram of a mobile device 10 according to some example embodiments of the inventive concepts.

Referring to FIG. 1, the mobile device 10, which is an example of an electronic device, may include a body housing 300, a metal frame 100 configured to surround a side portion of the body housing 300, and a rear cover 200.

The mobile device 10 may be an arbitrary mobile device, such as a smart phone, a cellular phone, a tablet PC, a laptop computer, a personal digital assistant (PDA), a portable multimedia player (PMP), a digital camera, a music player, a portable game console, or a navigation system.

The body housing 300 may be formed to frame the whole shape of the mobile device 10 and formed of insulating material, such as plastic. A printed circuit board (PCB) on which various electronic circuit chips or electric devices are mounted may be mounted in the body housing 300, and a camera module 330 including a camera lens 332 may be mounted on the body housing 300. A battery holder 340 capable of holding a battery may be formed in the body housing 300. A display screen or an input key button may be disposed in a front portion of the body housing 300.

A matching circuit 310, which is connected to an antenna segment 110 of the metal frame 100, and an NFC circuitry 320 connected to the matching circuit 310 may be mounted on the PCB disposed in the body housing 300.

In some example embodiments of the inventive concepts, the body housing 300 may be embodied by a PCB.

The metal frame 100 may include the antenna segment 110 formed of metal and a slit 120 configured to separate the antenna segment 110. The metal frame 100 may surround a side portion of the body housing 300 and protect the body housing 300 from an external impact.

The slit 120 may be filled with insulating material, such as plastic, ceramic, or glass, or dielectric material.

The metal frame 100 may be connected to the NFC circuitry 320 through the matching circuit 310, and constitute an antenna structure for NFC.

The rear cover 200 may be disposed to cover a rear surface of the body housing 300. An opening 210 may be formed in the rear cover 200. Meanwhile, when the rear cover 200 is attached to the body housing 300, the camera module 330 may be exposed through the opening 210. For example, the camera lens 332 may be exposed through the opening 210.

The rear cover 200 may be embodied using metal or insulating material, such as plastic. In some example embodiments of the inventive concepts, the rear cover 200 may be integrally formed with the body housing 300 of the mobile device 10.

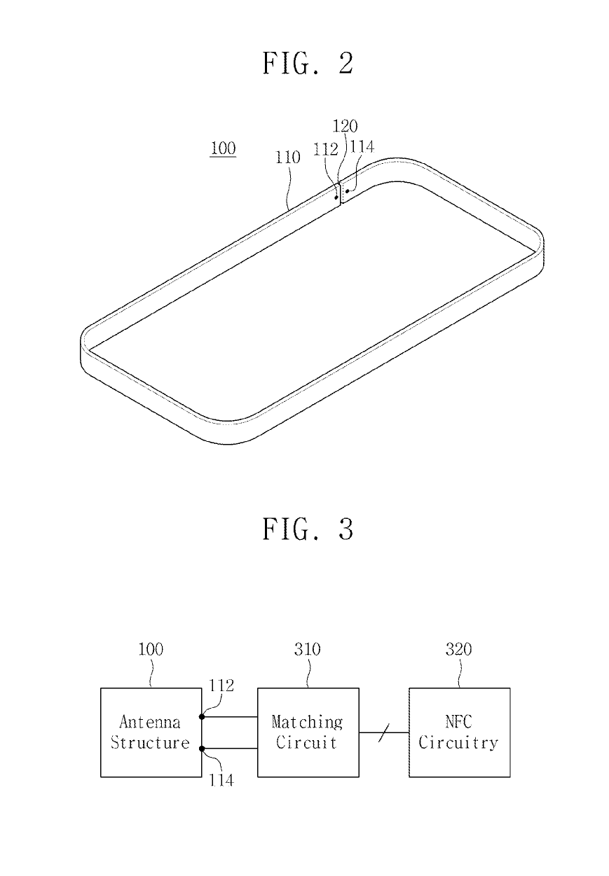

FIG. 2 is a diagram of a structure of the metal frame 100 of FIG. 1, according to some example embodiments of the inventive concepts.

Referring to FIG. 2, the metal frame 100 may have a rectangular frame shape having a desired height (that may or may not be predetermined) and a central hollow portion. The metal frame 100 may include the antenna segment 110 formed of metal. The slit 120 for separating the antenna segment 110 may be formed on one side of the antenna segment 110.

The antenna segment 110 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof. The antenna segment 110 may be formed of other metals or an alloy thereof.

An inner side surface and/or top and bottom surfaces of the antenna segment 110 may be coated with ferrite or magneto dielectric material (MDM) to prevent interference by peripheral radio frequency (RF) communication and improve antenna performance.

Feeding terminals 112 and 114 may be respectively formed at both ends of the antenna segment 110 and electrically connected to the matching circuit 310.

FIG. 3 is a block diagram of an NFC device according to some example embodiments of the inventive concepts.

Referring to FIGS. 1, 2, and 3, the metal frame 100 including the antenna segment 110 and the slit 120 may form an antenna structure.

The metal frame 100 may operate as a dedicated loop antenna for NFC of a mobile device. Conventionally, an additional NFC antenna may be attached to the inside of a mobile device or a rear cover or formed on a battery installed in a body housing. However, in some example embodiments of the inventive concepts, the metal frame 100 may function as an NFC antenna.

Thus, the rear cover 200 may become thinner. As a result, the mobile device may become thinner.

Conventionally, when a rear cover of a mobile device is formed of metal, an NFC antenna that is attached to the rear cover, attached to the inside of the mobile device, or formed on an outer surface of a battery installed in the mobile device may be shielded by the rear cover so that signals (e.g., electromagnetic waves (EMWs)) transmitted and received by the NFC antenna may be distorted.

However, in some example embodiments of the inventive concepts, since the metal frame 100 functions as an NFC antenna, the NFC device may precisely perform NFC without signal distortion.

The feeding terminal 112 of one end of the antenna segment 110 may be electrically connected to one end of the matching circuit 310, and the feeding terminal 114 of the other end of the antenna segment 110 may be electrically connected to the other end of the matching circuit 310.

The matching circuit 310 may perform impedance matching between the NFC circuitry 320 and the antenna segment 110.

The NFC circuitry 320 may perform NFC with an external device through the matching circuit 310 and the antenna segment 110. The NFC circuitry 320 may be a chip type.

In some example embodiments of the inventive concepts, the metal frame 100 may operate as a dedicated loop antenna for NFC.

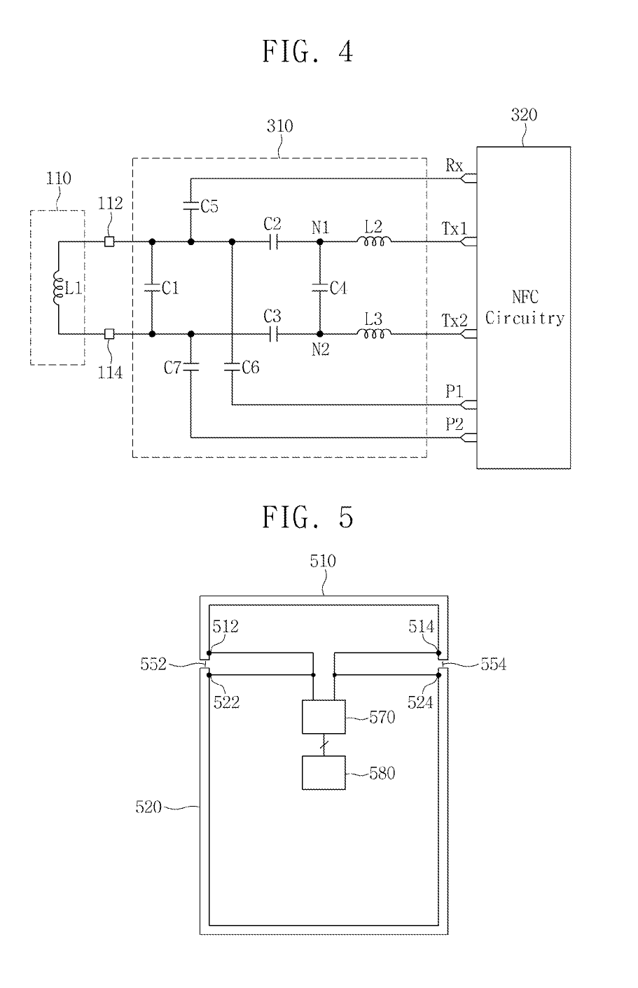

FIG. 4 is a circuit diagram of an NFC device according to some example embodiments of the inventive concepts.

Referring to FIG. 4, an NFC device included in a mobile device may include an antenna segment 110 formed of metal, a matching circuit 310, and an NFC circuitry 320. In some example embodiments of the inventive concepts, the NFC circuitry 320 may be a chip type.

The antenna segment 110 may be an antenna segment shown in FIGS. 1 and 2. The antenna segment 110 may operate as a dedicated loop antenna for NFC that is performed by the NFC circuitry 320 per se. The antenna segment 110 may not be directly grounded.

The antenna segment 110 may function as a first inductor L1 having a desired inductance (that may or may not be predetermined). One end of the antenna segment 110 may be connected to one end of a first capacitor C1 of the matching circuit 310 through a feeding terminal 112, and the other end of the antenna segment 110 may be connected to the other end of the first capacitor C1 through a feeding terminal 114.

Thus, the antenna segment 110 may operate as a resonator having an appropriate resonance frequency for NFC, along with the first capacitor C1 included in the matching circuit 310.

The matching circuit 310 may perform impedance matching between the antenna segment 110 and the NFC circuitry 320.

In one embodiment, the matching circuit 310 may include a second capacitor C2, a third capacitor C3, a fourth capacitor C4, a fifth capacitor C5, a sixth capacitor C6, a seventh capacitor C7, a second inductor L2, and a third inductor L3.

The second capacitor C2 may be connected between the feeding terminal 112 and a first node N1, and the third capacitor C3 may be connected between the feeding terminal 114 and a second node N2. Also, the fourth capacitor C4 may be connected between the first node N1 and the second node N2.

The second inductor L2 may be connected between the first node N1 and a first transmitting terminal Tx1 of the NFC circuitry 320, and the third inductor L3 may be connected between the second node N2 and a second transmitting terminal Tx2 of the NFC circuitry 320.

In addition, the fifth capacitor C5 may be connected between the feeding terminal 112 and a receiving terminal Rx of the NFC circuitry 320. The sixth capacitor C6 may be connected between the feeding terminal 112 and a first power terminal P1 of the NFC circuitry 320, and the seventh capacitor C7 may be connected between the feeding terminal 114 and a second power terminal P2 of the NFC circuitry 320.

The above-described configuration of the matching circuit 310 is only an example, and the matching circuit 310 may have one of various configurations for impedance matching between the antenna segment 110 and the NFC circuitry 320.

The NFC circuitry 320 may perform NFC with an external device through the matching circuit 310 and the antenna segment 110. The NFC circuitry 320 may be connected to the matching circuit 310 through the first power terminal P1, the second power terminal P2, the first transmitting terminal Tx1, the second transmitting terminal Tx2, and the receiving terminal Rx.

When the NFC circuitry 320 is an NFC chip, the NFC chip may perform a transmission operation and a receiving operation through the first power terminal P1 and the second power terminal P2 in an NFC card mode. In an NFC reader mode, the NFC chip may perform a transmission operation through the first transmitting terminal Tx1 and the second transmitting terminal Tx2, and perform a receiving operation through the receiving terminal Rx.

In some example embodiments of the inventive concepts, another antenna structure may be provided. Another antenna structure may include a frame formed of insulating material, such as plastic, and an inner side surface of the insulating frame may be coated with a metal pattern having a spiral shape or a metal pattern having an inductance and an arbitrary shape, and feeding terminals may be respectively formed at both ends of a separated metal pattern.

In addition, to control the inductance of a metal frame, an inner side surface of the frame may be coated with a metal pattern having a spiral shape or a metal pattern having an inductance and an arbitrary shape.

FIG. 5 is a configuration diagram of an NFC device according to an embodiment of the inventive concepts.

Referring to FIG. 5, a metal frame that forms an antenna structure may include two antenna segments including second and third antenna segments 510 and 520, and two slits including a second slit 552 and a third slit 554 formed between the second and third antenna segments 510 and 520.

The second and third antenna segments 510 and 520 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

Inner side surfaces and/or top and bottom surfaces of the second and third antenna segments 510 and 520 may be coated with ferrite or MDM to prevent interference by peripheral RF communication and improve performance.

Feeding terminals 512 and 514 may be respectively formed at both ends of the second antenna segment 510. Also, feeding terminals 522 and 524 may be respectively formed at both ends of the third antenna segment 520.

The feeding terminal 512 of the second antenna segment 510 and the feeding terminal 522 of the third antenna segment 520 may be connected in parallel to one end of a matching circuit 570, and the feeding terminal 514 of the second antenna segment 510 and the feeding terminal 524 of the third antenna segment 520 may be connected in parallel to the other end of the matching circuit 570.

The second slit 552 and the third slit 554 may be filled with insulating material, such as plastic, ceramic, or glass.

The matching circuit 570 may perform impedance matching between an NFC circuitry 580 and the antenna segments 510 and 520.

The NFC circuitry 580 may perform NFC with an external device through the matching circuit 570 and the antenna segments 510 and 520. The NFC circuitry 580 may be a chip type.

The matching circuit 570 and the NFC circuitry 580 are similar to those described with reference to FIGS. 3 and 4, and detailed descriptions thereof are omitted.

In some example embodiments of the inventive concepts, each of the second and third antenna segments 510 and 520 may operate as a dedicated loop antenna for NFC.

FIG. 6 is an equivalent circuit of the metal frame of FIG. 5, according to an embodiment of the inventive concepts.

Referring to FIGS. 5 and 6, the second antenna segment 510 may function as a fourth inductor L51 having a desired inductance (that may or may not be predetermined), and the third antenna segment 520 may function as a fifth inductor L52 having a desired inductance (that may or may not be predetermined). The second antenna segment 510 and the third antenna segment 520 may not be directly grounded.

The fourth inductor L51 may be electrically connected to the matching circuit 570 through the feeding terminals 512 and 514, and the fifth inductor L52 may be electrically connected to the matching circuit 570 through the feeding terminals 522 and 524.

Each of the fourth inductor L51 and the fifth inductor L52 may be connected in parallel to a desired capacitor (that may or may not be predetermined) (e.g., first capacitor C1 in FIG. 4) included in the matching circuit 570 and may operate as a resonator having an appropriate resonance frequency for NFC.

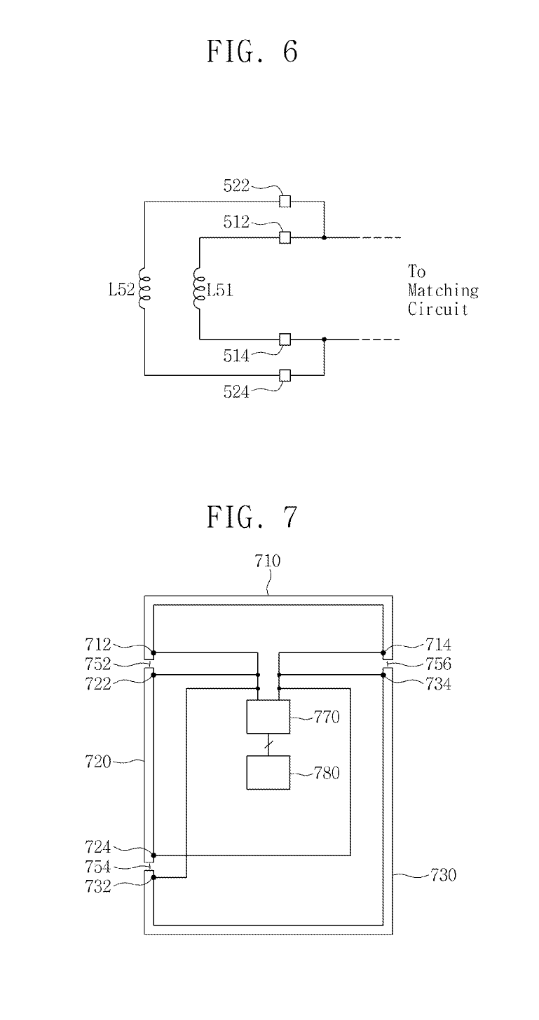

FIG. 7 is a configuration diagram of an NFC device according to an embodiment of the inventive concepts.

Referring to FIG. 7, a metal frame that forms an antenna structure may include three antenna segments including fourth, fifth, and sixth antenna segments 710, 720, and 730, and three slits including fourth, fifth, and sixth slits 752, 754, and 756 formed among the fourth, fifth, and sixth antenna segments 710, 720, and 730.

The fourth, fifth, and sixth antenna segments 710, 720, and 730 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

Inner side surfaces and/or top and bottom surfaces of the fourth, fifth, and sixth antenna segments 710, 720, and 730 may be coated with ferrite or MDM to prevent interference by peripheral RF communication and improve performance.

Feeding terminals 712 and 714 may be respectively formed at both ends of the fourth antenna segment 710. Feeding terminals 722 and 724 may be respectively formed at both ends of the fifth antenna segment 720. Also, feeding terminals 732 and 734 may be respectively formed at both ends of the sixth antenna segment 730.

The feeding terminal 712 of the fourth antenna segment 710, the feeding terminal 722 of the fifth antenna segment 720, and the feeding terminal 732 of the sixth antenna segment 730 may be connected in parallel to one end of a matching circuit 770. The feeding terminal 714 of the fourth antenna segment 710, the feeding terminal 724 of the fifth antenna segment 720, and the feeding terminal 734 of the sixth antenna segment 730 may be connected in parallel to the other end of the matching circuit 770.

The fourth, fifth, and sixth slits 752, 754, 756 may be filled with insulating material, such as plastic, ceramic, or glass.

The matching circuit 770 may perform impedance matching between an NFC circuitry 780 and the antenna segments 710, 720, and 730.

The NFC circuitry 780 may perform NFC with an external device through the matching circuit 770 and the antenna segments 710, 720, and 730. The NFC circuitry 780 may be a chip type.

The matching circuit 770 and the NFC circuitry 780 are similar to those described with reference to FIGS. 3 and 4, and detailed descriptions thereof are omitted.

In some example embodiments of the inventive concepts, each of the fourth, fifth, and sixth antenna segments 710, 720, and 730 may operate as a dedicated loop antenna for NFC.

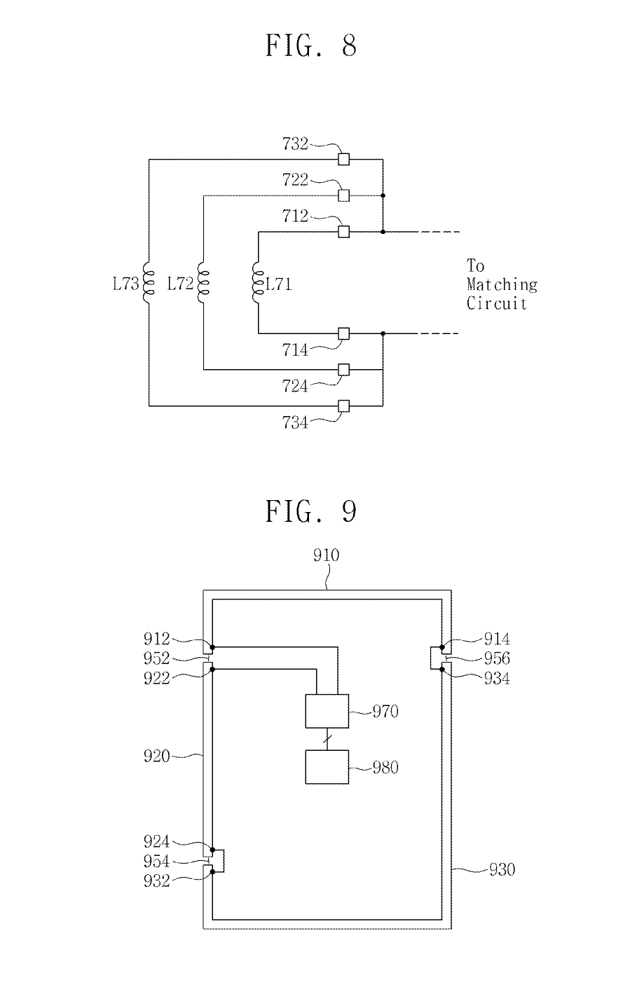

FIG. 8 is an equivalent circuit of the metal frame of FIG. 7, according to an embodiment of the inventive concepts.

Referring to FIGS. 7 and 8, the fourth antenna segment 710 may function as a sixth inductor L71 having a desired inductance (that may or may not be predetermined), the fifth antenna segment 720 may function as a seventh inductor L72 having a desired inductance (that may or may not be predetermined), and the sixth antenna segment 730 may function as an eighth inductor L73 having a desired inductance (that may or may not be predetermined).

The sixth inductor L71 may be electrically connected to the matching circuit 770 through the feeding terminals 712 and 714, and the seventh inductor L72 may be electrically connected to the matching circuit 770 through the feeding terminals 722 and 724. The eighth inductor L73 may be electrically connected to the matching circuit 770 through the feeding terminals 732 and 734.

Each of the sixth inductor L71, the seventh inductor L72, and the eighth inductor L73 may be connected in parallel to a desired capacitor (that may or may not be predetermined) (e.g., first capacitor C1 in FIG. 4) included in the matching circuit 770 and may operate as a resonator having an appropriate resonance frequency for NFC.

Although some example embodiments of the inventive concepts have described examples in which the metal frame includes one, two, or three antenna segments, the inventive concepts are not limited thereto. In some example embodiments of the inventive concepts, the metal frame may include four or more antenna segments, and each of the antenna segments may be electrically connected in parallel to a matching circuit.

In some example embodiments of the inventive concepts, a switch may be further provided between each of the antenna segments and the matching circuit and selectively connect the corresponding antenna segment and the matching circuit.

FIG. 15 is an equivalent circuit of FIG. 8, to which switches are added. Referring to FIG. 15, a first switch 51 may be connected in series between the sixth inductor L71 corresponding to the fourth antenna segment 710 and the matching circuit 770, a second switch S2 may be connected in series between the seventh inductor L72 corresponding to the fifth antenna segment 720 and the matching circuit 770, and a third switch S3 may be connected in series between the eighth inductor L73 corresponding to the sixth antenna segment 730 and the matching circuit 770.

Each of the switches 51, S2, and S3 may selectively connect the corresponding antenna segment with the matching circuit 770 in response to a respective control signal transmitted from a processor of the mobile device.

FIG. 9 is a configuration diagram of an NFC device according to an embodiment of the inventive concepts.

Referring to FIG. 9, a metal frame that forms an antenna structure may include three antenna segments including seventh, eighth, and ninth antenna segments 910, 920, and 930, and three slits including seventh, eighth, and ninth slits 952, 954, and 956 formed among the seventh, eighth, and ninth antenna segments 910, 920, and 930.

The seventh, eighth, and ninth antenna segments 910, 920, and 930 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

Inner side surfaces and/or top and bottom surfaces of the seventh, eighth, and ninth antenna segments 910, 920, and 930 may be coated with ferrite or MDM to prevent interference by peripheral RF communication and improve performance.

Feeding terminals 912 and 914 may be respectively formed at both ends of the seventh antenna segment 910. Feeding terminals 922 and 924 may be respectively formed at both ends of the eighth antenna segment 920. Feeding terminals 932 and 934 may be respectively formed at both ends of the ninth antenna segment 930.

The feeding terminal 924 of the eighth antenna segment 920 and the feeding terminal 932 of the ninth antenna segment 930 may be connected in series. The feeding terminal 934 of the ninth antenna segment 930 and the feeding terminal 914 of the seventh antenna segment 910 may be connected in series. The feeding terminal 912 of the seventh antenna segment 910 may be connected in one end of a matching circuit 970, and the feeding terminal 922 of the eighth antenna segment 920 may be connected to the other end of the matching circuit 970.

The seventh, eighth, and ninth slits 952, 954, 956 may be filled with insulating material, such as plastic, ceramic, or glass.

The matching circuit 970 may perform impedance matching between an NFC circuitry 980 and the antenna segments 910, 920, and 930.

The NFC circuitry 980 may perform NFC with an external device through the matching circuit 970 and the antenna segments 910, 920, and 930. The NFC circuitry 980 may be a chip type.

The matching circuit 970 and the NFC circuitry 980 are similar to those described with reference to FIGS. 3 and 4, and detailed descriptions thereof are omitted.

In some example embodiments of the inventive concepts, all of the seventh, eighth, and ninth antenna segments 910, 920, and 930 may operate as a dedicated loop antenna for NFC.

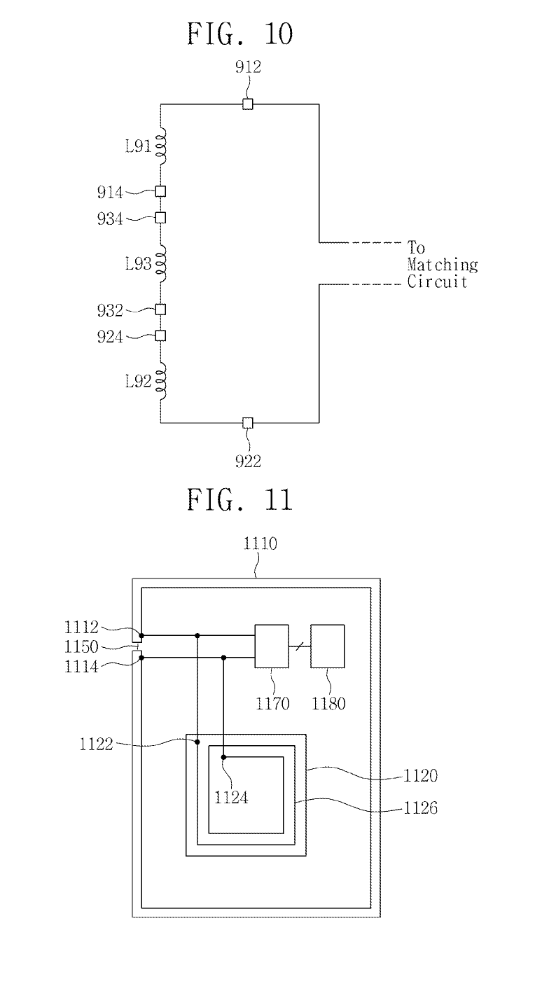

FIG. 10 is an equivalent circuit of the metal frame of FIG. 9, according to an embodiment of the inventive concepts.

Referring to FIGS. 9 and 10, the seventh antenna segment 910 may function as a ninth inductor L91 having a desired inductance (that may or may not be predetermined), and the eighth antenna segment 920 may function as a tenth inductor L92 having a desired inductance (that may or may not be predetermined). The ninth antenna segment 930 may function as an eleventh inductor L93 having a desired inductance (that may or may not be predetermined).

The ninth inductor L91, the tenth inductor L92, and the eleventh inductor L93 may be connected in series to one another. One end of the ninth inductor L91 may be electrically connected to one end of the matching circuit 970 through the feeding terminal 912, and one end of the tenth inductor L92 may be electrically connected to the other end of the matching circuit 970 through the feeding terminal 922.

The ninth inductor L91, the tenth inductor L92, and the eleventh inductor L93, which are connected in series to one another, may be connected in parallel to a desired capacitor (that may or may not be predetermined) (e.g., first capacitor C1 in FIG. 4) included in the matching circuit 970 and may operate as a resonator having an appropriate resonance frequency for NFC.

In some example embodiments of the inventive concepts, a metal frame may include two antenna segments or four or more antenna segments, and the antenna segments may be connected in series and connected to a matching circuit.

In some example embodiments of the inventive concepts, a metal frame may include three or more antenna segments, some of the antenna segments may be connected in series and connected to a matching circuit, and each of the remaining antenna segments may be connected in parallel to the matching circuit.

FIG. 11 is a configuration diagram of an NFC device according to an embodiment of the inventive concepts.

Referring to FIG. 11, an antenna structure may include a metal frame including a tenth antenna segment 1110 and a tenth slit 1150 configured to separate the tenth antenna segment 1110, and an NFC antenna 1120 including an NFC antenna pattern 1126.

The tenth antenna segment 1110 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

An inner side surface and/or top and bottom surfaces of the tenth antenna segment 1110 may be coated with ferrite or MDM to prevent interference by peripheral RF communication and improve performance.

Feeding terminals 1112 and 1114 may be respectively formed at both end ends of the tenth antenna segment 1110.

The NFC antenna 1120, which is a conventional NFC antenna, may be an NFC antenna film including the NFC antenna pattern 1126 formed on a base surface or a battery including the NFC antenna pattern 1126 formed on an outer surface of the battery.

Feeding terminals 1122 and 1124 may be respectively formed at both ends of the NFC antenna pattern 1126.

The feeding terminal 1112 of the tenth antenna segment 1110 and the feeding terminal 1122 of the NFC antenna 1120 may be connected in parallel to one end of a matching circuit 1170. The feeding terminal 1114 of the tenth antenna segment 1110 and the feeding terminal 1124 of the NFC antenna 1120 may be connected in parallel to the other end of the matching circuit 1170.

The tenth slit 1150 may be filled with insulating material, such as plastic, ceramic, or glass.

The matching circuit 1170 may perform impedance matching between an NFC circuitry 1180, and the tenth antenna segment 1110 and the NFC antenna pattern 1126.

The NFC circuitry 1180 may perform NFC with an external device through the matching circuit 1170, the tenth antenna segment 1110, and the NFC antenna pattern 1126. The NFC circuitry 1180 may be a chip type.

The matching circuit 1170 and the NFC circuitry 1180 are similar to those described with reference to FIGS. 3 and 4, and detailed descriptions thereof are omitted.

In some example embodiments of the inventive concepts, each of the tenth antenna segment 1110 and the NFC antenna pattern 1126 may operate as a dedicated loop antenna for NFC.

In some example embodiments of the inventive concepts, the NFC device may further include a switch interposed between the tenth antenna segment 1110 and the matching circuit 1170, and a switch interposed between the NFC antenna 1120 and the matching circuit 1170.

An equivalent circuit of the antenna structure of FIG. 11 is similar to that of FIG. 6, and descriptions thereof are omitted.

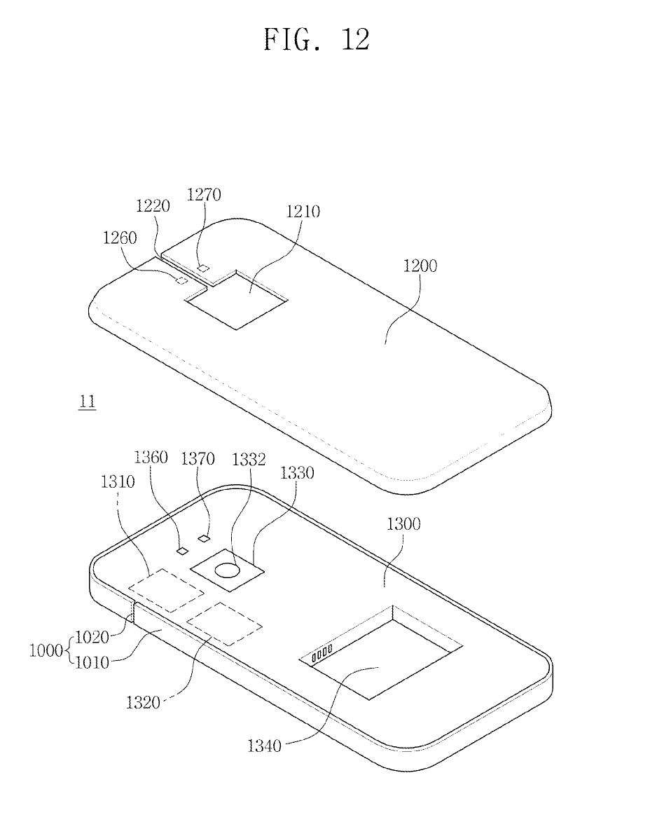

FIG. 12 is a configuration diagram of a mobile device 11 according to an embodiment of the inventive concepts.

Referring to FIG. 12, the mobile device 11, which is an example of an electronic device, may include a metal frame 1000 including an eleventh antenna segment 1010 and an eleventh slit 1020 configured to separate the tenth antenna segment 1110, and a rear cover 1200 including a slit 1220 and formed of metal, and a body housing 1300.

The eleventh antenna segment 1010 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

An inner side surface and/or top and bottom surfaces of the eleventh antenna segment 1010 may be coated with ferrite or magneto dielectric material (MDM) to prevent interference by peripheral RF communication and improve performance.

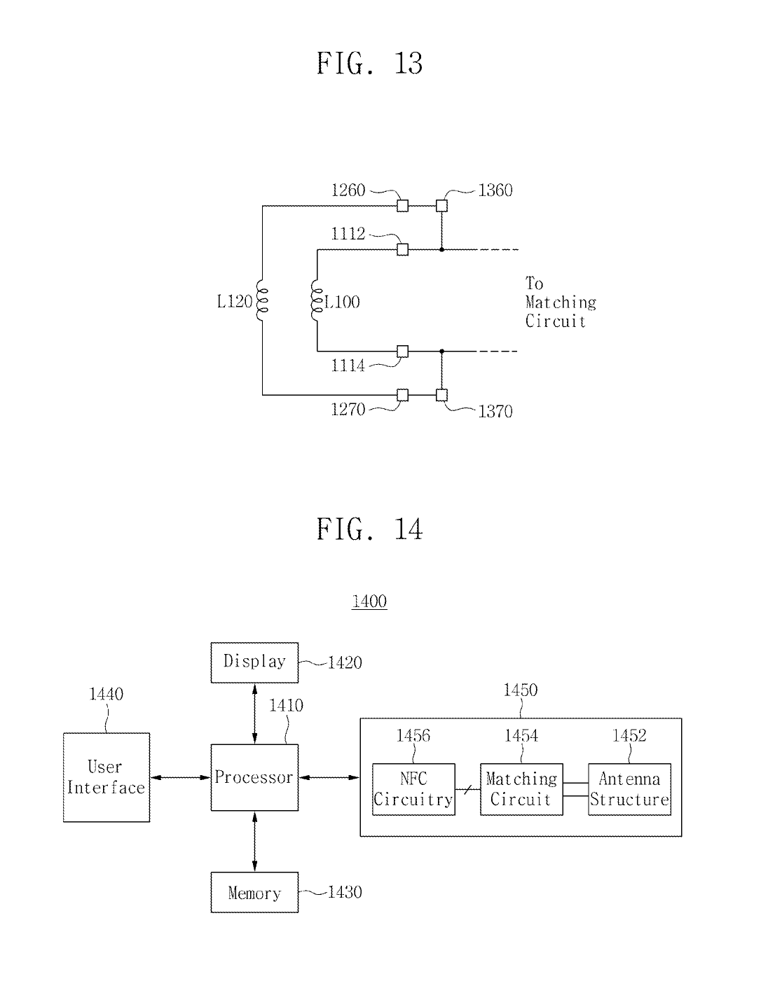

Like the feeding terminals 112 and 114 of FIG. 2, feeding terminals (refer to 1112 and 1114 in FIG. 13) may be respectively formed at both ends of the inner side surface of the eleventh antenna segment 1010.

The eleventh slit 1020 may be filled with insulating material, such as plastic, ceramic, or glass, or dielectric material.

The rear cover 1200 may be formed of at least one of copper (Cu), aluminum (Al), iron (Fe), titanium (Ti), silver (Ag), palladium (Pd), platinum (Pt), gold (Au), or nickel (Ni), or an alloy of at least two thereof.

Since the rear cover 1200 is formed of metal, the rear cover 1200 may be made thinner while maintaining a desired strength (that may or may not be predetermined). Thus, the mobile device 11 also may be made thinner.

An opening 1210 may be formed in one side of the rear cover 1200. The opening 1210 may be formed to expose some elements of the mobile device 11. For example, the opening 1210 may be a camera hole exposing a camera module 1330 of the mobile device 11.

The slit 1220 may be formed in the rear cover 1200 and extend from the opening 1210 to the outside. The slit 1220 may extend from one side of the opening 1210, in a vertical direction to the one side of the opening 1210, and have a smaller width than the opening 1210. In one embodiment, the slit 1220 may be partially or wholly filled with insulating material, such as plastic, ceramic, or glass.

Feeding terminals 1260 and 1270 may be formed at an inner side surface of the rear cover 1200 with the slit 1220 interposed therebetween.

When the rear cover 1200 is coupled with the body housing 1300, the feeding terminals 1260 and 1270 may be in contact with connection terminals 1360 and 1370 formed at the body housing 1300, and the rear cover 1200 may be electrically connected to a matching circuit 1310 through the connection terminals 1360 and 1370. In this case, the rear cover 1200 and the eleventh antenna segment 1010 may be electrically insulated from one another.

In some example embodiments of the inventive concepts, the rear cover 1200 may be integrally formed with the body housing 1300.

The body housing 1300 may be formed to frame the whole shape of the mobile device 11 and formed of insulating material, such as plastic. A PCB on which various chips are mounted may be mounted in the body housing 1300, and the camera module 1330 including a camera lens 1332 may be mounted on the body housing 1300. Also, a battery holder 1340 capable of holding a battery may be formed in the body housing 1300. A display screen or an input key button may be disposed in a front portion of the body housing 1300.

The matching circuit 1310, which is connected to the eleventh antenna segment 1010 of the metal frame 1000, and an NFC circuitry 1320 connected to the matching circuit 1310 may be formed on the PCB disposed in the body housing 1300.

The connection terminals 1360 and 1370 may be formed at one side of the body housing 1300 and electrically connected to the feeding terminals 1260 and 1270 of the rear cover 1200.

When the rear cover 1200 is coupled with the body housing 1300, the feeding terminal (refer to 1112 in FIG. 13) of the eleventh antenna segment 1010 and the feeding terminal 1260 of the rear cover 1200 may be connected in parallel to one end of a matching circuit 1310, and the feeding terminal (refer to 1114 in FIG. 13) of the eleventh antenna segment 1010 and the feeding terminal 1270 of the rear cover 1200 may be connected in parallel to the other end of the matching circuit 1310.

The matching circuit 1310 may perform impedance matching between the NFC circuitry 1320, and the eleventh antenna segment 1010 and the rear cover 1200.

The NFC circuitry 1320 may perform NFC with an external device through the matching circuit 1310, the eleventh antenna segment 1010, and the rear cover 1200. The NFC circuitry 1320 may be a chip type.

The matching circuit 1310 and the NFC circuitry 1320 are similar to those described with reference to FIGS. 3 and 4, and detailed descriptions thereof are omitted.

In some example embodiments of the inventive concepts, each of the eleventh antenna segment 1010 and the rear cover 1200 may operate as a dedicated loop antenna for NFC.

In some example embodiments of the inventive concepts, the mobile device 11 may further include a switch interposed between the eleventh antenna segment 1010 and the matching circuit 1310, and a switch interposed between the rear cover 1200 and the matching circuit 1310.

FIG. 13 is an equivalent circuit of an antenna structure of FIG. 12, according to an embodiment of the inventive concepts.

Referring to FIGS. 12 and 13, the eleventh antenna segment 1010 may function as a twelfth inductor L100 having a desired inductance (that may or may not be predetermined), and the rear cover 1200 may function as a thirteenth inductor L120 having a desired inductance (that may or may not be predetermined).

The twelfth inductor L100 may be electrically connected to the matching circuit 1310 through the feeding terminals 1112 and 1114, and the thirteenth inductor L120 may be electrically connected to the matching circuit 1310 through the feeding terminals 1260 and 1270 and the connection terminals 1360 and 1370.

Each of the twelfth inductor L100 and the thirteenth inductor L120 may be connected in parallel to a desired capacitor (that may or may not be predetermined) (e.g., first capacitor C1 in FIG. 4) included in the matching circuit 1310 and operate as a resonator having an appropriate resonance frequency for NFC.

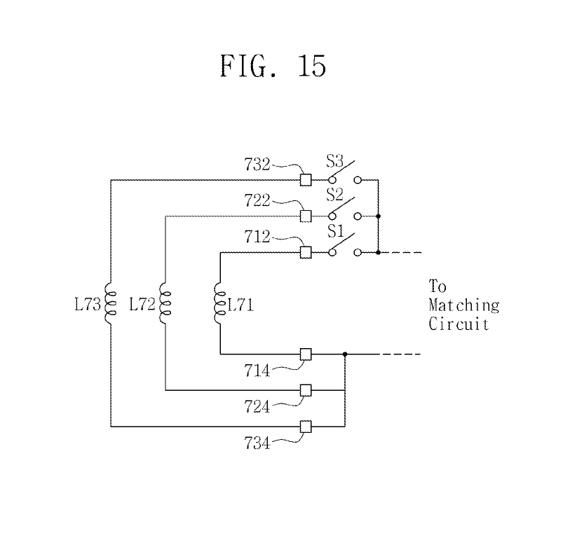

FIG. 14 is a block diagram of a mobile device 1400 according to an embodiment of the inventive concepts.

Referring to FIG. 14, the mobile device 1400 may include a processor 1410, a display 1420, a memory 1430, a user interface 1440, and an NFC device 1450.

The mobile device 1400 may be an arbitrary mobile device, such as a smart phone, a cellular phone, a personal digital assistant (PDA), a PMP, a digital camera, a music player, a portable game console, a navigation system, or a laptop computer.

The processor 1410 may control general operations of the mobile device 1400. In one embodiment, the processor 1410 may be an application processor (AP) configured to execute applications capable of providing the Internet browser, games, and moving images.

In some example embodiments of the inventive concepts, the processor 1410 may be a single-core processor or a multi-core processor. For example, the processor 1410 may include a multi-core, such as a dual-core, a quad-core, or a hexa-core.

The display 1420 may receive image signals processed by the processor 1410 and display images in response to the received image signals. The display 1420 may be a liquid crystal display (LCD), a light emitting diode (LED), a plasma display panel (PDP), or an organic light emitting diode (OLED).

The memory 1430 may store data required for operations of the mobile device 1400. For instance, the memory 1430 may store a boot image for booting the mobile device 1400, and store data transmitted to and received from an external device.

The memory 1430 may be embodied by a volatile memory, such as a dynamic random access memory (DRAM), a static random access memory (SRAM), a mobile DRAM, a double data rate synchronous dynamic RAM (DDR SDRAM), a low-power DDR SDRAM (LPDDR SDRAM), a graphics DDR (GDDR) SDRAM, or a Rambus DRAM (RDRAM). Alternatively, the memory 1430 may be embodied by a non-volatile memory, such as an electrically erasable programmable read-only memory (EEPROM), a flash memory, a phase-change RAM (PRAM), a resistive RAM (RRAM), a nano-floating gate memory (NFGM), a polymer RAM (PoRAM), a magnetic RAM (MRAM), or a ferroelectric RAM (FRAM).

The user interface 1440 may include at least one input device, such as a keypad or a touch screen.

The NFC device 1450 may perform NFC with an external device. The NFC device 1450 may include an antenna structure 1452 according to an embodiment of the inventive concepts, a matching circuit 1454 configured to perform impedance matching between the antenna structure 1452 and an NFC circuitry 1456, and the NFC circuitry 1456 configured to perform NFC with an external device through the antenna structure 1452 and the matching circuit 1454.

In some example embodiments of the inventive concepts, the mobile device 1400 may further include an image processor. In some example embodiments of the inventive concepts, the mobile device 1400 may further include a storage device, such as a memory card, a solid-state drive (SSD), a hard disk drive (HDD), or a compact disc read-only memory (CD-ROM).

Elements of the mobile device 1400 may be mounted using packages having various shapes. For example, the elements of the mobile devices 1400 may be mounted using a package on package (PoP) technique, a ball grid array (BGA) technique, a chip-scale package (CSP) technique, a plastic-leaded chip carrier (PLCC) technique, a plastic dual in-line package (PDIP) technique, a die-in-waffle-pack technique, a die-in-wafer-form technique, a chip-on-board (COB) technique, a ceramic dual in-line package (CERDIP) technique, a plastic metric quad flat-pack (MQFP) technique, a thin quad flat-pack (TQFP) technique, a small outline (SOIC) technique, a shrink small outline package (SSOP) technique, a thin small outline (TSOP) technique, a thin quad flat-pack (TQFP) technique, a system-in-package (SIP) technique, a multi-chip package (MCP) technique, a wafer-level fabricated package (WFP) technique, or a wafer-level processed stack package (WSP) technique.

Meanwhile, a mobile device including an NFC device according to some example embodiments of the inventive concepts may exhibit excellent NFC antenna performance even if a rear cover is formed of metal. Also, the mobile device may exhibit excellent NFC antenna performance both in front and rear directions thereof.

Furthermore, according to some example embodiments of the inventive concepts, since a metal frame of a mobile device and/or a metal rear cover may be used as an antenna for NFC, fabrication costs may be reduced, and the mobile device may be downsized.

The inventive concepts may be used for NFC devices and mobile devices using the NFC devices.

According to some example embodiments of the inventive concepts as described above, a mobile device can use a metal frame as an NFC antenna to improve performance of an NFC antenna.

Furthermore, a mobile device according to some example embodiments of the inventive concepts can use a metal frame as an NFC antenna. Thus, an additional antenna for NFC may not be required, thereby reducing fabrication costs.

Although some example embodiments have been described, those skilled in the art will readily appreciate that many modifications are possible without materially departing from the novel teachings and advantages. Accordingly, all such modifications are intended to be included within the scope of this inventive concepts as defined in the claims.

1. A near-field communication (NFC) device, comprising:
an NFC circuitry configured to perform NFC;
an antenna structure connected to the NFC circuitry; and
a matching circuit configured to perform impedance matching between the NFC circuitry and the antenna structure;
wherein the antenna structure comprises: an antenna segment configured to form a metal frame surrounding a periphery of a body including the NFC circuitry and the matching circuit, and a first slit formed between first and second ends of the antenna segment,
wherein the antenna segment comprises a first feeding terminal and a second feeding terminal respectively formed at the first and second ends of the antenna segment, and
wherein the first feeding terminal of the antenna segment is connected to a first end of the matching circuit, and the second feeding terminal of the antenna segment is connected to a second end of the matching circuit.

2. The NFC device of claim 1, wherein the antenna segment is not directly grounded.

3. The NFC device of claim 1, wherein the antenna segment is connected in parallel to a capacitor included in the matching circuit, and
wherein the antenna segment is configured to operate as a resonator having an appropriate resonance frequency for the NFC.

4. The NFC device of claim 1, wherein the antenna structure further comprises an NFC antenna including an NFC antenna pattern, and
wherein the NFC antenna and the antenna segment are connected in parallel to the matching circuit.

5. The NFC device of claim 1, wherein the antenna structure further comprises a cover configured to protect the body and formed of metal,
wherein the cover comprises a second slit formed at one side of the cover and comprises a third feeding terminal and a fourth feeding terminal formed with the second slit interposed therebetween,
wherein the third feeding terminal and the first feeding terminal are connected in parallel to the first end of the matching circuit, and
wherein the fourth feeding terminal and the second feeding terminal are connected in parallel to the second end of the matching circuit.

6-7. (canceled)

8. A near-field communication (NFC) device, comprising:
an NFC circuitry configured to perform NFC;
an antenna structure connected to the NFC circuitry; and
a matching circuit configured to perform impedance matching between the NFC circuitry and the antenna structure;
wherein the antenna structure comprises: a plurality of antenna segments configured to form a metal frame surrounding a periphery of a body including the NFC circuitry and the matching circuit, and a plurality of slits formed among the plurality of antenna segments,
wherein each of the plurality of antenna segments comprises a first feeding terminal and a second feeding terminal respectively formed at first and second ends of the respective antenna segment, and
wherein the first feeding terminals are connected in parallel to a first end of the matching circuit, and the second feeding terminals are connected in parallel to a second end of the matching circuit.

9. The NFC device of claim 8, wherein each of the plurality of antenna segments is not directly grounded.

10. The NFC device of claim 8, wherein each of the plurality of antenna segments is connected in parallel to a capacitor included in the matching circuit, and
wherein each of the plurality of antenna segments is configured to operate as a resonator having an appropriate resonance frequency for the NFC.

11-18. (canceled)

19. An electronic device comprising the NFC device of claim 1, wherein the electronic device is configured to perform NFC with an external device through the NFC device.

20. The electronic device of claim 19, wherein the electronic device is a mobile device.

21. An electronic device comprising the NFC device of claim 8, wherein the electronic device is configured to perform NFC with an external device through the NFC device.

22. The electronic device of claim 21, wherein the electronic device is a mobile device.

23-24. (canceled)

25. The NFC device of claim 4, wherein the NFC device further comprises a first switch, interposed between the antenna segment and the matching circuit, and a second switch, interposed between the NFC antenna and the matching circuit.

26. The NFC device of claim 5, wherein the NFC device further comprises a first switch, interposed between the antenna segment and the matching circuit, and a second switch, interposed between the cover and the matching circuit.

27. A near-field communication (NFC) device, comprising:
NFC circuitry configured to perform NFC;
an antenna structure configured to transmit and receive radio frequency communications;
a matching circuit configured to perform impedance matching between the NFC circuitry and the antenna structure; and
a body comprising the NFC circuitry and the matching circuit;
wherein the antenna structure comprises an antenna segment configured to form a metal frame on a periphery of the body,
wherein the antenna segment comprises a first feeding terminal at a first end of the antenna segment,
wherein the antenna segment comprises a second feeding terminal at a second end of the antenna segment, and
wherein the first and second feeding terminals are connected to the matching circuit.

28. The NFC device of claim 27, wherein the antenna segment is not directly grounded.

29. The NFC device of claim 27, wherein the antenna segment is connected in parallel to a capacitor in the matching circuit.

30. The NFC device of claim 27, wherein the antenna segment is configured to operate as a resonator having an appropriate resonance frequency for the NFC.

31. The NFC device of claim 27, wherein the antenna structure further comprises an NFC antenna including an NFC antenna pattern.

32. The NFC device of claim 31, wherein the NFC antenna and the antenna segment are connected in parallel to the matching circuit.
